(19) United States
(12) Patent Application Publication
(10) Pub. No.: US 2013/0186661 A1
(43) Pub. Date: Jul. 25, 2013

(54) Power Tool

(71) Applicants: Takahiro Okubo, Hitachinaka (JP); Kazutaka Iwata, Hitachinaka (JP)

(72) Inventors: Takahiro Okubo, Hitachinaka (JP); Kazutaka Iwata, Hitachinaka (JP)

(73) Assignee: Hitachi Koki Co., Ltd., Tokyo (JP)

(21) Appl. No.: 13/639,150

(22) PCT Filed: Sep. 13, 2011
(86) PCT No.: PCT/JP2011/071295

§ 371 Date: Oct. 3, 2012

(30) Foreign Application Priority Data
Sep. 30, 2010 (JP) 2010-221364

(51) Int. Cl. B25F 5/00

(52) U.S. Cl. CPC B25F 5/00
USPC 173/2

(57) ABSTRACT

A power tool including: a housing configured to support an end bit, a motor accommodated in the housing, a transmission mechanism, a trigger switch, a load judging unit, and a motor stop control unit. The transmission mechanism transmits a rotational force of the motor to the end bit. The trigger switch is configured to switch between instructions to the motor. The instructions include a rotation instruction for providing a rotation state of the motor and a stopping instruction for providing a stopping state of the motor. The load judging unit judges whether or not a load is applied to the end bit during rotation of the motor. The motor stop control unit stops the rotation of the motor irrespective of the instructions of the trigger switch when the load judging unit judges that no load is applied to the end bit and a period of a non-load state exceeds a predetermined time period.

### TECHNICAL FIELD

The invention relates to a power tool, and more specifically to a power tool capable of drilling a workpiece by an end bit.

### BACKGROUND ART

Drilling devices are conventionally known, such as a hammer drill that drills a hole in a workpiece by rotating a drill bit and applying a striking force to the drill bit. A drilling device includes, for generating a striking force, a motor, a cylinder, a piston disposed in the cylinder, a motion converting mechanism that converts a rotational force of the motor into reciprocating motion of the piston, a striking piece driven by the piston, and an intermediate piece hit by the striking piece. A drill bit is mounted on an end part of the drilling device. The striking piece hits the intermediate piece so that the striking force is transmitted to the drill bit via the intermediate piece. The rotational force of the motor is transmitted to the drill bit, so that the end bit rotates about its axial center.

The motor is at a stopped phase if a trigger switch is not operated by a user. Rotation of the motor is started upon operation to the trigger switch. More specifically, in accordance with the manipulation amount (depression amount) of the trigger switch, applied voltage to the motor is changed for controlling rotation number of the motor. Generally, the applied voltage is increased in proportion to an increase in depression amount of the trigger switch to increase the rotation number of the motor. Such trigger switch is disclosed in Japanese Patent Application Publication No. H8-66084.

### DISCLOSURE OF INVENTION

### Technical Problem

The drilling device such as a hammer drill is provided with an on-lock button. The on-lock button is configured to maintain a state of the trigger switch to continue rotation of the motor even if the user's finger is released from the trigger switch. By way of the on-lock button, rotation of the motor can be continued after release of the finger from the trigger switch as long as the trigger switch is provisionally depressed. The rotation of the motor is started, when the trigger switch is operated for rotating the motor in a state where the on-lock button is activated, and the rotation of the motor is continued as long as the on-lock button is activated.

In a design of the above-described power tool, a sensitive reaction is required such that the rotation of the motor is highly responsive to the delicate manipulation to the trigger switch. Therefore, rotation of the motor is started upon a minute depression of the trigger switch. For example, rotation of the motor is started and the rotation is maintained if an ambient component is brought into contact with the trigger switch in a state where a power supply voltage is applicable to the motor, for example in a state where a battery is attached to the power tool in case of a cordless power tool, or in a state where a power tool is connected to a power outlet in case of the AC powered tool.

In case of the cordless power tool, the battery becomes over discharge state if the rotation of the motor is continued, and service life of the battery may be shortened. In case of the AC powered tool, the continuous rotation of the motor may cause damage to the tool body and/or ambient working environment.

Accordingly, it is an object of the present invention to provide a power tool capable of preventing the motor from being continuously rotated if the rotation of the motor is unintentionally started.

### Solution to Problem

This and other objects of the present invention will be attained by a power tool including: a housing configured to support an end bit, a motor accommodated in the housing, a transmission mechanism, a trigger switch, a load judging unit, and a motor stop control unit. The transmission mechanism transmits a rotational force of the motor to the end bit. The trigger switch is configured to switch a state of the motor. The load judging unit judges whether or not a load is applied to the end bit during rotation of the motor. The motor stop control unit stops the rotation of the motor irrespective of the state of the trigger switch when the load judging unit judges that no load is applied to the end bit and a period of a non-load state exceeds a predetermined time period.

With this configuration, continuation of the rotation of the motor can be avoided even if the rotation of the motor is unintentionally started. Consequently, any damage to the power tool or to a working site ambient to the power tool can be avoided. Further, over-discharge of the battery can be avoided, if the power tool is a cordless tool.

It is preferable that the load judging unit includes a detecting unit that detects the rotation state of the motor. A judgment of whether or not a load is applied to the end bit is based on detection by the detecting unit

With this configuration, detection of non-load can be made by detecting the rotating state of the motor.

It is preferable that the detecting unit includes a current detecting unit that detects an electric current flowing through the motor. A judgment of whether or not a load is applied to the end bit is based on a magnitude of the electrical current detected by the current detecting unit.

With this configuration, electrical current flowing through the motor can be used for detecting non-loaded state of the end bit.

It is preferable that the detecting unit includes a rotation number detecting unit that detects a rotation number of the motor. A judgment of whether or not a load is applied to the end bit is based on a magnitude of the rotation number detected by the rotation number detecting unit

With this configuration, rotation number of the motor 21 can be used for detecting non-loaded state of the end bit.

It is preferable that the detecting unit includes a vibration sensor. A judgment of application of no load to the end bit is made when the vibration sensor does not detects a vibration

With this configuration, existence or non-existence of impact can be utilized for detecting of the non-loaded state of the end bit.

It is preferable that the motor stop control unit judges whether the trigger switch provides the rotation instruction to the motor or the stopping instruction to the motor. The motor is rotated when the trigger switch provides the rotation instruction to the motor after the motor stop control unit judges that the trigger switch provides the stopping instruction.

With this configuration, the motor can again be rotated by temporarily providing the stopping instruction from the trigger switch and then providing the rotation instruction from the trigger switch after the rotation of the motor is stopped by the motor stop control unit.

It is preferable that the motor is a DC brushless motor.

With this configuration, a compact power tool can be provided.

### BRIEF DESCRIPTION OF DRAWINGS

FIG. 1 is a cross-sectional view of a power tool according to an embodiment of the present invention;

FIG. 2 is a explanatory diagram showing a motor of the power tool according to the embodiment of the present invention;

FIG. 3 is a circuit diagram showing a control circuit section, an inverter circuit section and a motor of the power tool according to the embodiment of the present invention;

FIG. 4 is a flowchart illustrating steps in a controlling procedure of the power tool according to the embodiment of the present invention;

FIG. 5 is a flowchart illustrating steps in a controlling procedure of the power tool according to a first modification to the controlling procedure shown in FIG. 4; and

FIG. 6 is a flowchart illustrating steps in a controlling procedure of the power tool according to a second modification to the controlling procedure shown in FIG. 4.

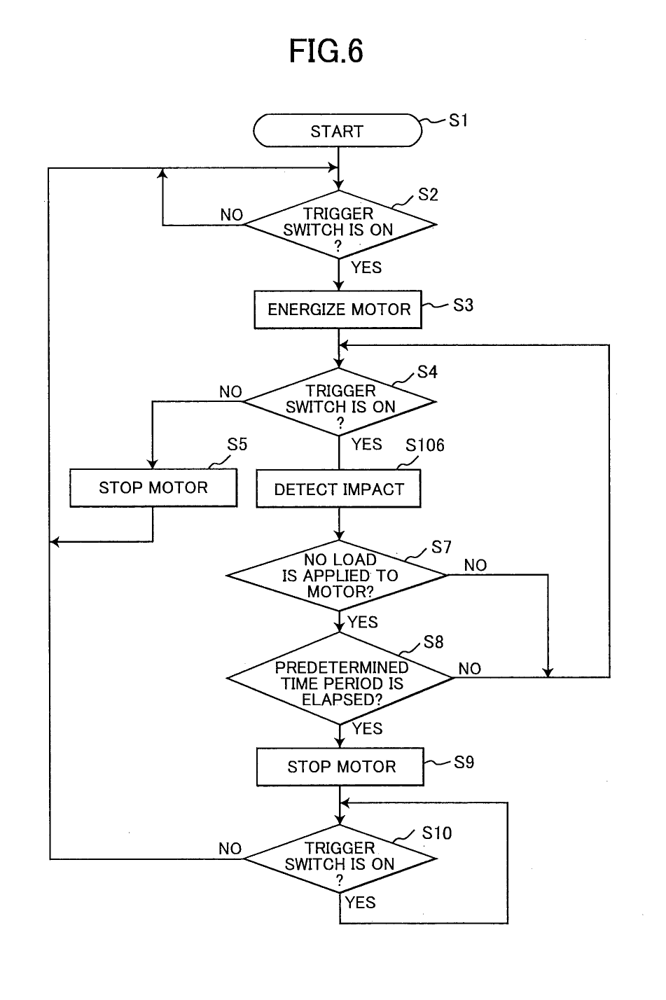

### MODE FOR CARRYING OUT THE INVENTION

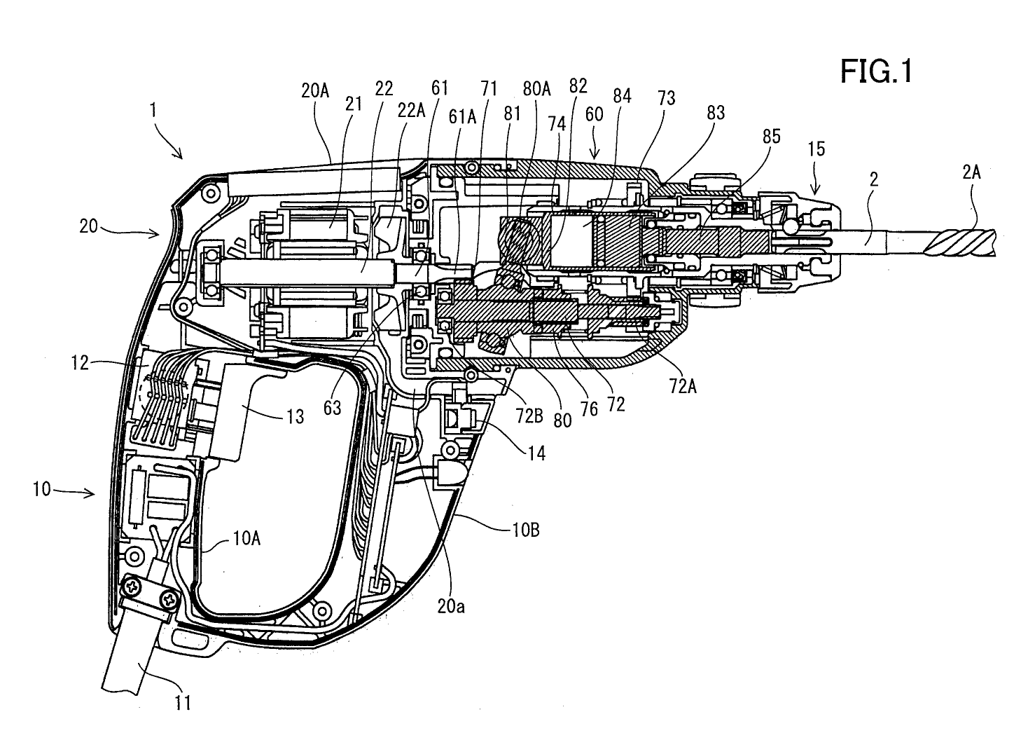

An embodiment of a power tool according to the invention will be described while referring to FIGS. 1 through 4. As shown in FIG. 1, a power tool 1 is a rotary hammer drill for drilling a hole into a workpiece W. A housing of the power tool 1 is formed by a handle section 10, a motor housing 20, and a gear housing 60. Hereinafter, the front-to-rear direction is defined so that the right side in FIG. 1 (the tip end side of a drill bit 2) is the front side of the drilling device 1. Further, the upper-to-lower direction is defined so that the direction perpendicular to the front-to-rear direction. A side in which the handle section 10 extends from the motor housing 20 is the lower side in the upper-to-lower direction. The workpiece W is located at the front side of the drilling device 1. The length of the housing in the front-to-rear direction, that is, the length in the left-to-right direction in FIG. 1 is approximately 30 cm (centimeters) to 40 cm.

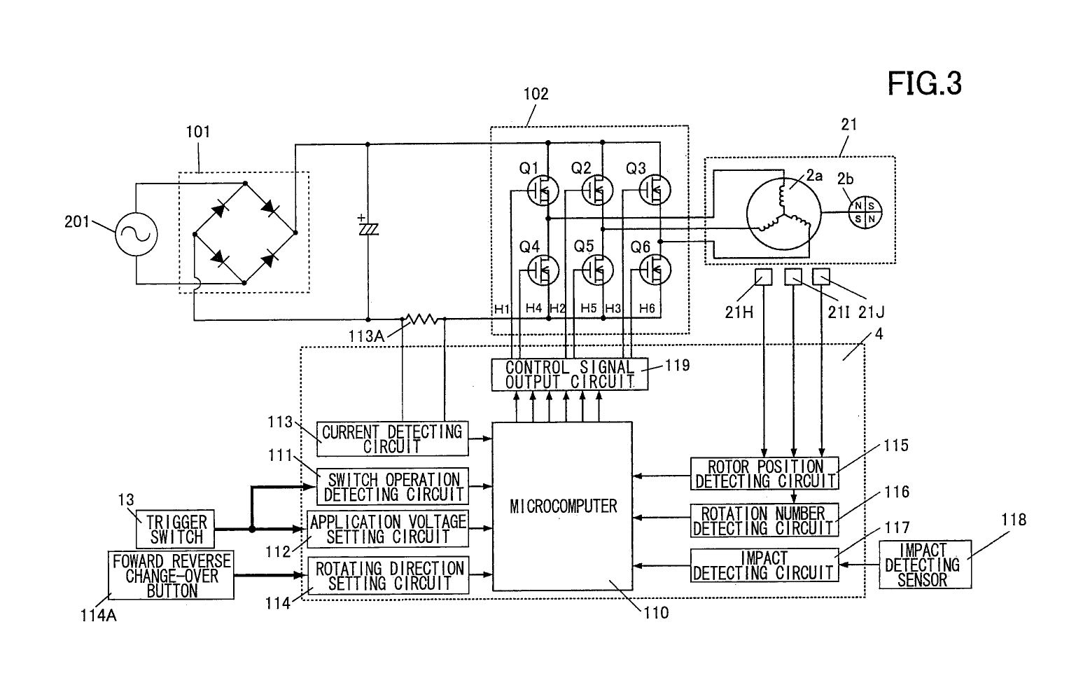

The handle section 10 is integrally molded with plastic and has substantially a U-shape. A motor accommodating section 20A is defined above the handle section 10. The motor accommodating section 20A constitutes part of the motor housing 20 and accommodates a motor 21 described later. A power cable 11 is attached to a lower section of a rear section 10A of the handle section 10. Also, a switch mechanism 12 connected to the motor 21 described later is built in the rear section 10A of the handle section 10. The switch mechanism 12 is mechanically connected to a trigger switch 13 that can be operated by an operator. By operating the trigger switch 13, supply or stopping of power to an inverter circuit section 102 (FIG. 3) is switched. Further, adjustment in manipulation amount of the trigger switch 13 can control rotation number of the motor 2. The depression state of the trigger switch 13 corresponds to rotation state of the motor, and non-depression state of the trigger switch 13 corresponds to stopping state of the motor. Such state is instructed from the user, i.e., depression or non-depression of the trigger switch 13 is provided by the user.

A forward reverse change-over button 114A is provided on the motor housing 20 as shown in FIG. 3. Each time the forward reverse change-over button 114A is depressed by the user, the rotating direction of the motor 21 is altered. For example, an end bit 2 (described later) will be rotated in a clockwise direction for drilling when the trigger switch 13 is operated as long as the forward reverse change-over button 114A has been depressed to provide the forward rotation. On the other hand, the end bit 2 will be rotated in a counterclockwise direction to be removed out of the drilling when the forward reverse change-over button 114A is again depressed.

A distance sensor 14 is provided at an upper front end portion 10B of the handle section 10. The distance sensor 14 is configured to measure a distance between the distance sensor 14 and a workpiece to be drilled that is in confrontation with the distance sensor 14 in the front-to-rear direction.

The motor 21 shown in FIG. 1 is a three-phase direct-current brushless motor. Rotation of the motor 21 is controlled by a microcomputer 110 described later. The motor 21 includes an output shaft 22 extending toward the front side and having an axial direction in the front-to-rear direction. The output shaft 22 outputs a rotational driving force. An axial fan 22A is provided at a base section of the output shaft 22 so as to be rotatable coaxially and together with the output shaft 22.

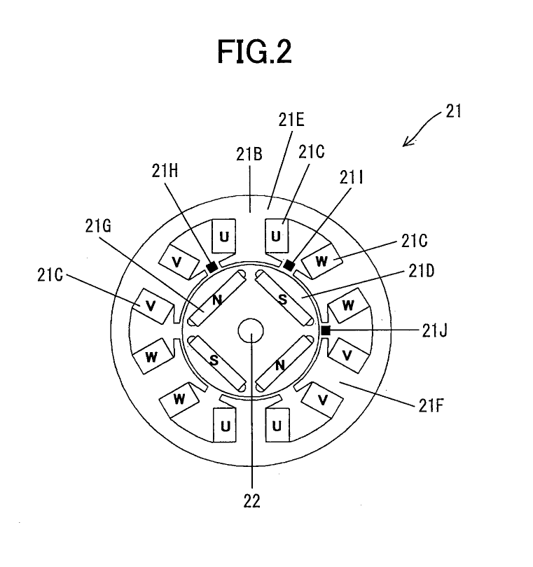

An internal magnet incorporated type three-phase brushless DC motor is available as the motor 21. As shown in FIG. 2, the motor 21 includes a stator 21B, a three-phase (U,V,W) stator windings 21C, and a rotor 21D. The stator 21B has an outer portion in a cylindrical shape, and includes a sleeve portion 21E, and six teeth portions 21F extending radially inwardly from the sleeve portion 21E.

The three-phase (U,V,W) stator windings 21C are in the form of a star connection, and each winding is wound over a pair of teeth portions 21F positioned at diametrically opposite sides of the sleeve portion 21E through an electrically insulating layer such as a resin material. The rotor 21D is positioned at radially inward of the teeth portions 21F, and includes an output shaft 22 and permanent magnets 21G. N poles and S poles of the magnets 21G extend in an axial direction of the output shaft 22 and are positioned alternately at every 90 degrees in the rotating direction of the rotor 21D.

Three Hall IC 21H, 21I, 21J are arrayed in the rotating direction at every 60 degrees at positions adjacent to the rotor 21D. These Hall ICs 21H, 21I, 21J are configured to detect magnetic force from the permanent magnet 21G by way of electromagnetic coupling type detection, and to output a rotation position detection signal. Incidentally, instead of the Hall ICs, a sensor-less type detection is available in which a counter-electromotive force of the stator windings 21C is retrieved through a filter as a logic signal to detect the rotational position.

As shown in FIG. 1, an air passage 20a is provided at a position below the axial fan 22A. The air passage 20a extends downward from the axial fan 22A, and is communicated with spaces confronting an upper portion, a front end portion, and a rear end portion of the distance sensor 14. Upon rotation of the axial fan 22A, air is introduced to a position adjacent to the motor 21 through an air inlet formed in a rear portion of the motor housing 20, and the air passes through the air passage 20a and along the upper and rear portions of the distance sensor 14 to cool the distance sensor 14. Further, the air also passes along the front portion of the distance sensor 14. This air can prevent the drilling chips formed by the rotation of the end bit 2 from being deposited onto the surface of the distance sensor 14.

The gear housing 60 is formed by resin molding, and is provided at the front side of the motor housing 20. Within the gear housing 60, a first intermediate shaft 61 is provided to extend from the output shaft 22 and to be coaxial with the output shaft 22.

The first intermediate shaft 61 is rotatably supported by a bearing 63. The rear end of the first intermediate shaft 61 is coupled to the output shaft 22. A fourth gear 61A is provided at the front end of the first intermediate shaft 61. Within the gear housing 60, a second intermediate shaft 72 is supported, in parallel with the output shaft 22, by a bearing 72B so as to be rotatable about its axial center.

A fifth gear 71 meshingly engaged with the fourth gear 61A is coaxially fixed to the rear end of the second intermediate shaft 72. A gear section 72A is formed at the front side of the second intermediate shaft 72. The gear section 72A is meshingly engaged with a sixth gear 73 described later. A cylinder 74 is provided at a position within the gear housing 60 and above the second intermediate shaft 72. The cylinder 74 extends in parallel with the second intermediate shaft 72 and is supported rotatably. The sixth gear 73 is fixed to the outer circumference of the cylinder 74. The cylinder 74 is rotatable about its axial center by meshing engagement with the above-described gear section 72A.

An end bit holding section 15 is provided at the front side of the cylinder 74. The end bit 2 described later can be detachably mounted on the end bit holding section 15. An intermediate part of the second intermediate shaft 72 is in spline engagement with a clutch 76 that is urged rearward by a spring. The clutch 76 can be switched between a hammer drill mode and a drill mode by a change lever (not shown) provided at the gear housing 60. At the motor 21 side of the clutch 76, a motion converting mechanism 80 for converting rotational motion into reciprocating motion is rotatably provided at the outside of the second intermediate shaft 72. An arm section 80A of the motion converting mechanism 80 is movable reciprocally in the front-to-rear direction of the drilling device 1 by rotation of the second intermediate shaft 72.

A piston 82 is provided within the cylinder 74. The piston 82 is mounted so as to be capable of reciprocating in the direction parallel to the axial direction of the second intermediate shaft 72 and to be movable slidably within the cylinder 74. A striking piece 83 is provided within the piston 82. An air chamber 84 is defined between the piston 82 and the striking piece 83 within the cylinder 74. An intermediate piece 85 is provided within the cylinder 74 at the opposite side from the air chamber 84 with respect to the striking piece 83 so as to be slidable in the moving direction of the piston 82. The end bit 2 is located at a position at the opposite side from the striking piece 83 with respect to the intermediate piece 85. Thus, the striking piece 83 can hit the end bit 2 via the intermediate piece 85.

When the clutch 76 is switched to the hammer drill mode, the second intermediate shaft 72 and the motion converting mechanism 80 are coupled by the clutch 76. The motion converting mechanism 80 is connected so as to interlock, via a piston pin 81, with the piston 82 provided within the cylinder 74.

As shown in FIG. 1, the end bit 2 is a drill bit and includes a drill 2A. The end bit 2 drills a hole into the workpiece W by rotating and reciprocating in its axial direction. The end bit 2 is detachable from the end bit holding section 15 and is exchangeable.

Next, a circuit diagram including a control circuit section having a microcomputer (computing portion) 110, an inverter circuit section 102, and a motor circuit will be described. The control circuit section includes a switch operation detecting circuit 111, an application voltage setting circuit 112, a current detecting circuit 113, rotating direction setting circuit 114, a rotor position detecting circuit 115, a rotation number detecting circuit 116, an impact detecting circuit 117, and a control signal output circuit 119. A combination of the microcomputer 110, the current detecting circuit 113, a shunt resistance 113A, the rotor position detecting circuit 115, the rotation number detecting circuit 116, the impact detecting sensor 118, and the impact detecting circuit 117 corresponds to a load judging unit, and the microcomputer 110 corresponds to a motor stop control unit. Further, the impact detecting sensor 118 corresponds to a vibration sensor.

The current detecting circuit 113 is configured to detect a voltage developed across a shunt resistance 113A provided on a path to the motor 21 and having a minute resistance value, to thus detect a motor current, and to output the detected motor current to the microcomputer 110. The switch operation detecting circuit 111 is adapted to detect depression or non-depression of the trigger switch 13, and to output to the microcomputer 110. The applied voltage setting circuit 112 is configured to set PWM duty of PWM drive signal that drives switching elements Q1 through Q6 in the inverter circuit section 102 in accordance with a target value signal transmitted from the trigger switch 13, and to output the PWM duty to the microcomputer 110.

The forward reverse change-over button 114A is adapted to change rotating direction of the motor between forward and reverse rotations. The forward reverse change-over button 114A is connected to the rotating direction setting circuit 114. The rotor position detecting circuit 115 is adapted to detect rotating position of the rotor 21D based on rotating position detecting signal outputted from the three Hall IC 21H, 21I, 21J, and to output the detected rotating position signal to the microcomputer 110 and the rotation number detecting circuit 116. The rotation number detecting circuit 116 is adapted to detect rotation number of the motor 21 based on the detected position detected by the rotor position detecting circuit 115, and output the rotation number to the microcomputer 110.

The impact detecting circuit 117 is connected to the impact detecting sensor 118. The impact detecting sensor 118 is provided by an acceleration sensor making use of piezoelectric effect. The impact detecting sensor 118 is adapted to output analog signal indicative of amplitude, cycle and frequency in accordance with the magnitude of impact, and the analog signal is converted by the impact detecting circuit 117 into a digital signal, i.e., pulse signal that can be recognized in the microcomputer 110.

The microcomputer 110 calculates a target value of PWM duty based on outputs from the application voltage setting circuit 112. The microcomputer 110 also determines a stator winding to be appropriately energized based on outputs from the rotor position detecting circuit 115, and generates output switching signals H1 through H3 and PWM driving signals H4 through H6. Duty widths of the PWM driving signals H4 through H6 are determined based on the target value of PWM duty, and then the PWM driving signals H4 through H6 are outputted. The control signal output circuit 119 outputs the output switching signals H1 through H3 and the PWM driving signals H4 through H6 to the inverter circuit section 102.

Alternate current (AC) power from a commercial power source is supplied to the inverter circuit section 102 via a rectifier circuit 101. In the inverter circuit section 102, switching elements are driven based on the output switching signals H1 through H3 and the PWM driving signals H4 through H6, and the stator winding to be energized is determined Further, the PWM driving signal is switched by the target value of PWM duty. Thus, three-phase AC voltages with electric angle of 120 degrees are applied sequentially to three-phase stator windings (U, V, W) of the motor 21. Further, in the inverter circuit section 102, the switching elements can be driven so as to stop rotation of the output shaft 22 based on signals from the microcomputer 110 via the control signal output circuit 119.

When the motor 21 of the above-described power tool 1 is driven, a rotational output is transmitted to the second intermediate shaft 72 via the first intermediate shaft 61, the fourth gear 61A, and the fifth gear 71. Rotation of the second intermediate shaft 72 is transmitted to the cylinder 74 by meshingly engagement between the gear section 72A and the sixth gear 73, and rotational force is transmitted to the end bit 2. When the clutch 76 is moved to the hammer drill mode, the clutch 76 couples with the motion converting mechanism 80, and rotational driving force of the second intermediate shaft 72 is transmitted to the motion converting mechanism 80. In the motion converting mechanism 80, rotational driving force is converted into reciprocating motion of the piston 82 via the piston pin 81. The reciprocating motion of the piston 82 causes pressure of air in the air chamber 84 defined between the striking piece 83 and the piston 82 to repeat increasing and decreasing, so that a striking force is applied to the striking piece 83. The striking piece 83 moves forward and hits the rear end surface of the intermediate piece 85, and a striking force is transmitted to the end bit 2 via the intermediate piece 85. In this way, in the hammer drill mode, both of the rotational force and striking force are applied to the end bit 2 simultaneously.

When the clutch 76 is in the drill mode, the clutch 76 cuts off connection between the second intermediate shaft 72 and the motion converting mechanism 80, and only rotational driving force of the second intermediate shaft 72 is transmitted to the cylinder 74 via the gear section 72A and the sixth gear 73. Hence, only the rotational force is applied to the end bit 2.

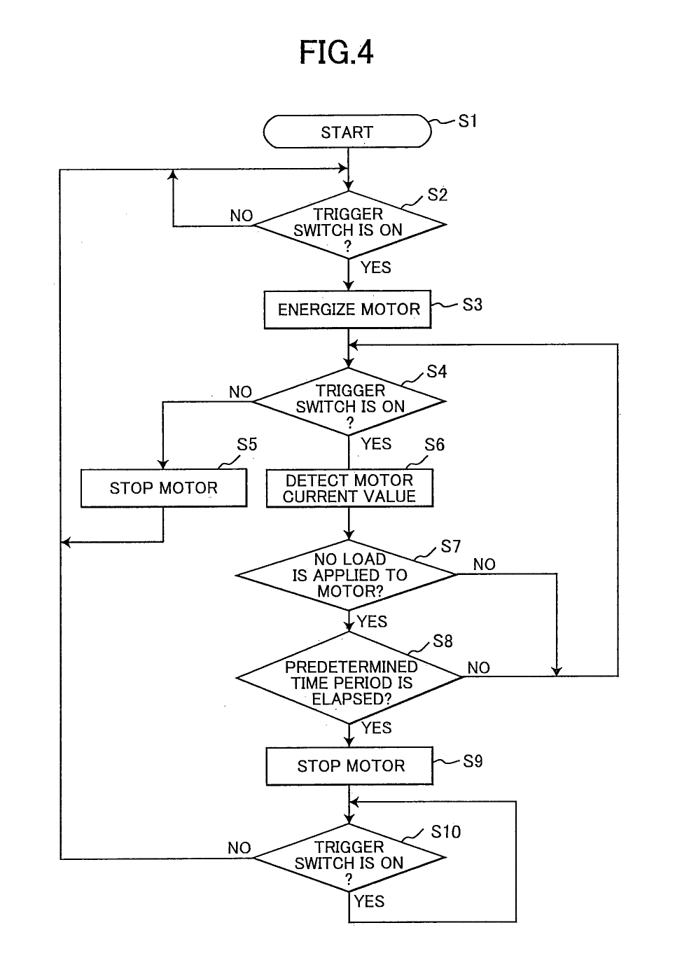

A controlling procedure of the microcomputer 110 upon operation to the trigger switch 13 will be described. In the following description, the depressing state of the trigger switch 13 will be referred to as “trigger switch 13 ON” and non-depression state of the trigger switch 13 will be referred to as “trigger switch 13 OFF”. First, as shown in FIG. 4, the microcomputer 110 judges whether or not the trigger switch 13 is rendered ON (S2). If the trigger switch 13 is rendered OFF (S2:NO), the microcomputer 110 returns to S2.

If the trigger switch 13 is rendered ON (S2:YES), the microcomputer 110 energizes the motor 12 (S3), and the microcomputer 110 judges whether or not the trigger switch 13 is rendered ON (S4). If the trigger switch 13 is not turned ON (S4:NO), rotation of the motor 21 is stopped (S5), and the microcomputer 110 judges again whether or not the trigger switch 13 is rendered ON (S2).

If the trigger switch 13 is rendered ON (S4:YES), electric current flowing through the motor 21 is detected (S6), the electric current being indicative of rotation state of the motor 21. Then, the microcomputer 110 judges whether or not the rotation is made without application of load to the motor 21 (S7). This judgment can be performed by judging whether or not the detected motor current exceeds a predetermined current level. If the drilling is performed with the end bit 2, load is applied to the motor 21, so that the detected motor current exceeds the predetermined current level. In this case, in S7 judgment falls NO. Then, the microcomputer 110 returns to S4 to again judges whether or not the trigger switch 13 is rendered ON.

When the microcomputer 110 determines that no load is applied to the motor 21 (the end bit 2 is rotated idly without performing drilling) because the detected current does not exceeds the predetermined current level (S7:YES), in S8 the microcomputer 110 judges whether or not a predetermined time period is elapsed from detection start timing. If the predetermined time period has not yet been elapsed (S8:NO), the microcomputer 110 returns back to S4. If the predetermined time period has been elapsed (S8:YES), the microcomputer 110 stops rotation of the motor 21 (S9).

Then, in S10 the microcomputer 110 judges whether or not a state of the trigger switch 13 remains the ON state. If the trigger switch 13 is still ON state (S10: YES), the microcomputer 110 returns back to S10 to again judge ON state of the trigger switch 13. If the trigger switch 13 is rendered OFF (S10: NO), the microcomputer 110 returns to S2.

According to the above-described control, rotation of the motor 21 is stopped irrespective of depression state of the trigger switch 13 if no load is applied to the end bit 2 during rotation of the motor 21 and the period of the non-load state exceeds the predetermined time period. Accordingly, continuation of the rotation of the motor 21 can be avoided even if the rotation of the motor 21 is unintentionally started. Consequently, any damage to the power tool 1 or to a working site ambient to the power tool 1 can be avoided. Further, over-discharge of the battery can be avoided, if the power tool 1 is a cordless tool.

Further, the load judging unit is adapted to judge application of load to the end bit 2 by detecting rotating state of the motor 21. Therefore detection of non-load can be made by detecting the rotating state of the motor 21.

Further, the load judging unit is provided with the current detecting circuit 113 and the shunt resistance 113A as a current detection unit, and judgment is made as to whether or not load is applied to the end bit 2 based on the magnitude of electrical current detected by the current detecting circuit 113 and the shunt resistance 113A. In this way, electrical current flowing through the motor 21 can be used for detecting the non-loaded state.

Further, the rotation of the motor 21 is provided when the trigger switch 13 is operated to ON after the trigger switch 13 is judged to be OFF. In this way, the motor 21 can again be rotated by temporarily turning OFF the trigger switch 13 and then turning ON after the rotation of the motor 21 is stopped under the control of the microcomputer 110.

Further, the motor 21 is the DC brushless motor, and therefore, a compact power tool 1 can be provided.

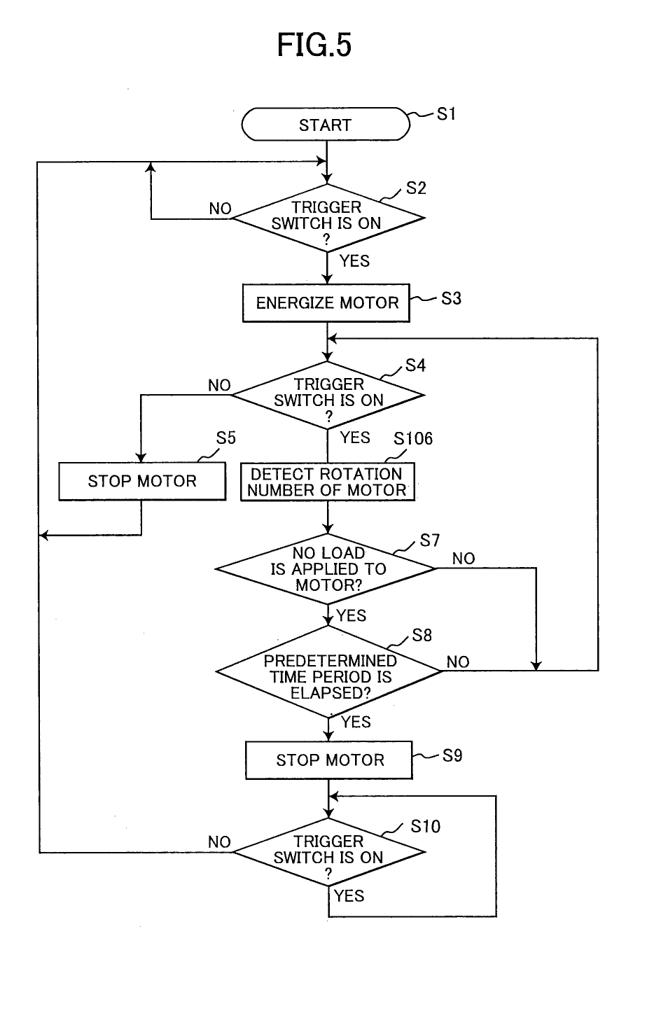

Various modifications are conceivable. For example, in the above-described embodiment, motor current is detected (S6) and judgment of non-loaded state is performed by judging whether or not the detected motor current exceeds the predetermined current level (S7). According to a first modification, as shown in a flowchart of FIG. 5, rotation number of the motor 21 is detected by the rotor position detecting circuit 115 and the rotation number detecting circuit 116 (S106) instead of the detection of the motor current, and the judgment goes on to non-loaded state if the rotation number is greater than a predetermined number (S107: YES), and judgment goes onto to loaded state if the rotation number is smaller than the predetermined number (S107: NO).

Further, according to a second modification, impact is detected by the impact detection sensor 118 (S206). Judgment goes on to non-loaded state if the magnitude of detected impact is lower than a predetermined level (S207: YES), and judgment goes onto loaded state if the magnitude of detected impact is higher than the predetermined level (S207: NO).

Further, among three types of detection and judgment process of the above-described embodiment, the first modification, and the second modification, two types of detection and judgment process can be executed sequentially in a control procedure. Alternatively, three types of detection and judgment process can be executed sequentially in a control procedure in order to make judgment of non-loaded state or loaded state. Accordingly, in the power tool 1 of the above described embodiment, the current detecting circuit 113, the shunt resistance 113A, the rotor position detecting circuit 115, the rotation number detecting circuit 116, the impact detecting circuit 117 and the impact detection sensor 118 are provided. However, some of the components and circuits can be dispensed with to perform the judgment of non-loaded state or loaded state.

According to the first modification, judgment of non-loaded state or loaded state of the end bit 2 is performed based on rotation number detected by the rotation number detecting circuit 116 and the rotor position detecting circuit 115. Therefore, rotation number of the motor 21 can be used for the judgment. Further, according to the second modification, judgment of non-loaded state of the end bit 2 is performed based on detection of no vibration detected by the impact detecting circuit 117 and the impact detection sensor 118. Therefore, existence or non-existence of impact can be utilized for the detection of the non-loading state.

Further, the power tool 1 according to the embodiment is the hammer drill. However, power tools other than the hammer drill are also available such as a driver drill and an impact driver. Further, instead of the brushless DC motor, a commutator motor is also available.

Further, instead o the forward reverse change-over button 114A, a lever is provided to the trigger switch 13 for changing rotating direction of the motor 21. Further, instead of piezoelectric type impact detection sensor 118, other type of acceleration sensor can be used. Further, instead of the power tool 1 connected to the commercial power supply, a cordless power tool accommodating therein a battery is also available.

Further, in the above-described embodiment, the trigger switch 13 is configured to adjust rotation number of the motor 21 by adjusting operation amount of the trigger switch. However, other type of trigger switch is also available. For example, rotation state or stopping state cannot be recognized by a state or position of the trigger switch. The trigger switch is configured to return to its initial position after being depressed to obtain rotation state, and to also return to its initial position after being depressed again to obtain non-rotation state.

While the invention has been described in detail and with reference to specific embodiment thereof, it would be apparent to those skilled in the art that various changes and modifications may be made therein without departing from the scope of the invention.

### INDUSTRIAL APPLICABILITY

The invention is especially useful in the field of a portable type power tool.

### REFERENCE SIGNS LIST

1 power tool

2 end bit

10 handle section

13 trigger switch

20 motor housing

21 motor

22 output shaft

60 gear housing

110 microcomputer

113 current detecting circuit

113A shunt resistance

115 rotor position detecting circuit

116 rotation number detecting circuit

117 impact detecting circuit

118 impact detecting sensor

1. A power tool comprising:
a housing configured to support an end bit;
a motor accommodated in the housing;
a transmission mechanism transmitting a rotational force of the motor to the end bit;
a trigger switch configured to switch a state of the motor; and
a load judging unit that judges whether or not a load is applied to the end bit during rotation of the motor,
characterized in that:
a motor stop control unit that stops the rotation of the motor irrespective of the state of the trigger switch when the load judging unit judges that no load is applied to the end bit and a period of a non-load state exceeds a predetermined time period.

2. The power tool according to claim 1, wherein the load judging unit comprises a detecting unit that detects the rotation state of the motor, a judgment of whether or not a load is applied to the end bit being based on detection by the detecting unit.

3. The power tool according to claim 2, wherein the detecting unit comprises a current detecting unit that detects an electric current flowing through the motor, a judgment of whether or not a load is applied to the end bit being based on a magnitude of the electrical current detected by the current detecting unit.

4. The power tool according to claim 2, wherein the detecting unit comprises a rotation number detecting unit that detects a rotation number of the motor, a judgment of whether or not a load is applied to the end bit being based on a magnitude of the rotation number detected by the rotation number detecting unit.

5. The power tool according to claim 2, wherein the detecting unit comprises a vibration sensor, a judgment of application of no load to the end bit being made when the vibration sensor does not detects a vibration.

6. The power tool according to claim 1, wherein the motor stop control unit judges whether the trigger switch provides the rotation instruction to the motor or the stopping instruction to the motor, and
wherein the motor is rotated when the trigger switch provides the rotation instruction to the motor after the motor stop control unit judges that the trigger switch provides the stopping instruction.

7. The power tool according to claim 1, wherein the motor is a DC brushless motor.
